(19) United States
(12) Patent Application Publication
(10) Pub. No.: US 2026/0039705 A1
(43) Pub. Date: Feb. 5, 2026

(54) Server-Side Buffering Of Push-To-Talk Messages

(71) Applicant: Zoom Communications, Inc., San Jose, CA (US)

(72) Inventors: Patrick Robert Donald Baird, Aguilar, CO (US); Vi Dinh Chau, Seattle, WA (US); Nick Swerdlow, Santa Clara, CA (US)

(21) Appl. No.: 18/788,630

(22) Filed: Jul. 30, 2024

(51) Int. Cl. H04L 65/4061; H04L 65/613; H04L 65/80

(52) U.S. Cl. CPC H04L 65/4061; H04L 65/613; H04L 65/80

(57) ABSTRACT

A push-to-talk server receives a request from a client device to initiate a push-to-talk communication with one or more recipient devices. The push-to-talk server receives, from the client device, an audio recording recorded during a latency period between initiation of the push-to-talk communication at the client device and receipt of the request by the push-to-talk server. The push-to-talk server transmits the audio recording to the one or more recipient devices. The push-to-talk server receives real-time audio from the client device. The push-to-talk server buffers the real-time audio for transmission to the one or more recipient devices after completion of playback of the audio recording.

### FIELD

This disclosure relates to push-to-talk communication, such as those that may be used with software implemented at a push-to-talk server and a push-to-talk client.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a push-to-talk system.

FIG. 5 is a block diagram of an example of an artificial intelligence engine that may execute at a push-to-talk server.

FIG. 6 is a data flow diagram of a first example of a push-to-talk communication technique.

FIG. 7 is a data flow diagram of a second example of a push-to-talk communication technique.

FIG. 8 illustrates an example of audio input and audio output of a push-to-talk communication technique.

FIG. 9 is a flowchart of an example of a technique for buffering push-to-talk messages.

FIG. 10 is a flowchart of an example of a technique for buffering a message at a client.

FIG. 11 is a flowchart of an example of a technique for processing buffered audio at a server.

### DETAILED DESCRIPTION

In a push-to-talk (PTT) system, multiple PTT client devices (such as walkie-talkies or mobile phone applications) communicate with a server, which may be local to the client devices or in a remote location with respect to the client devices. When a user presses the PTT button on their client device, the user's client device establishes a connection with the server, which then broadcasts the audio from the user's client device to all other clients in the same channel or group. While the user holds the PTT button, the audio from their client device is typically transmitted in real-time. When the button is released, the connection is terminated, and the user can hear, via their client device receiving, transmissions from other users. The server manages these connections, controls access to channels, and ensures smooth communication between the connected client devices. PTT has many use cases. For example, PTT may be used by workers in a warehouse, a large store, or a restaurant to facilitate real-time (or near real-time, for example, with a delay of a few seconds or under one minute) communication among certain individuals in a large (e.g., one acre) space.

In some cases, multiple PTT users at multiple client devices may attempt to speak at the same time. In such circumstances, techniques for selecting a client device from which to transmit audio may be desirable. Furthermore, in some cases, a user of a client device may press the PTT button and immediately begin speaking before their client device connects to the server and begins broadcasting. This causes the server and the recipient devices to fail to process the first few seconds of audio (before the connection between the client device and the server is established), potentially causing users of the recipient devices to fail to hear crucial information. Techniques for ensuring that all of the audio from the speaking user's client device is captured and transmitted may be desirable.

Implementations of this disclosure address problems such as these using PTT software and/or hardware. According to some implementations, in a PTT system, a server is transmitting audio from a sender client device to recipient client devices, and the audio is being played back at the recipient client devices. During playback of the audio, users of one or more of the recipient client devices press the PTT button to interrupt the sender and to begin speaking themselves. The server receives the audio messages from these recipient client devices and stores the audio in a buffer in an order based on an initiation time associated with the audio messages. The server uses an artificial intelligence (AI) engine to determine an importance score for at least a portion of the messages in the buffer and reorders some of the messages based on importance scores. For a “thin” server that is not capable of running a transformer-based AI engine (e.g., a large language model (LLM) or a generative pretrained transformer (GPT)) in a short amount of time (e.g., a few seconds), the importance score may be determined using a convolutional neural network (CNN) based on nonverbal features (e.g., voice tonality or volume). For a server that is capable of running a transformer-based AI engine in the short amount of time, verbal features (e.g., the natural language words in the audio) may be considered by the AI engine at the server in determining the importance score. In some cases, if an audio message is determined to be unimportant (e.g., a recently fired worker ranting about their firing), the audio message may be removed from the buffer without being transmitted to the recipient client devices. In some cases, if an audio message is determined to be very important (e.g., a message indicating a fire in the building), the audio being played back may be interrupted to play the very important message.

According to some implementations, a user pushes the PTT button on a client device to initiate a process for generating an audio message. The client device records a first part of the audio message and stores the first part in a buffer of the client device. The client device connects to the server and receives a confirmation that the server has connected to the client device. The client device transmits real-time audio to the server and transmits the recorded audio from the buffer to the server. The server transmits the recorded audio to the recipient devices and buffers, at the server, the real-time audio from the client device. The buffered audio at the server is transmitted to the recipient devices for playback at the recipient devices after completion of the playback of the audio recording. As a result, the first interval of audio (e.g., between 0.1 seconds and 2 seconds) is broadcast from the client device to the recipient devices, and the recipient devices hear the audio from the client device with a latency determined based on the connection time of the client device to the server.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

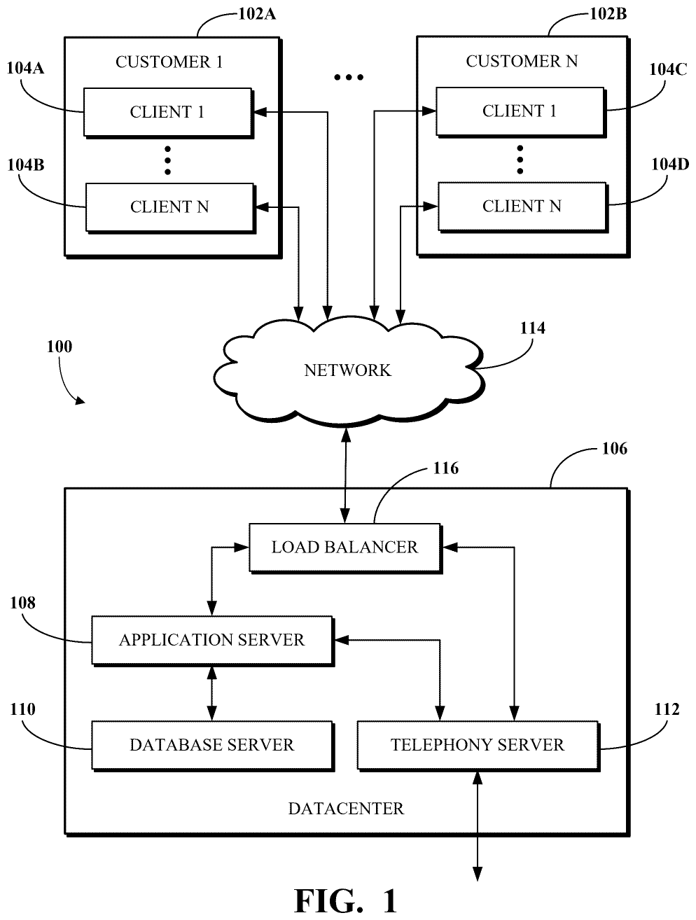

To describe some implementations in greater detail, reference is first made to examples of hardware and software structures used to implement a PTT system for buffering PTT messages. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

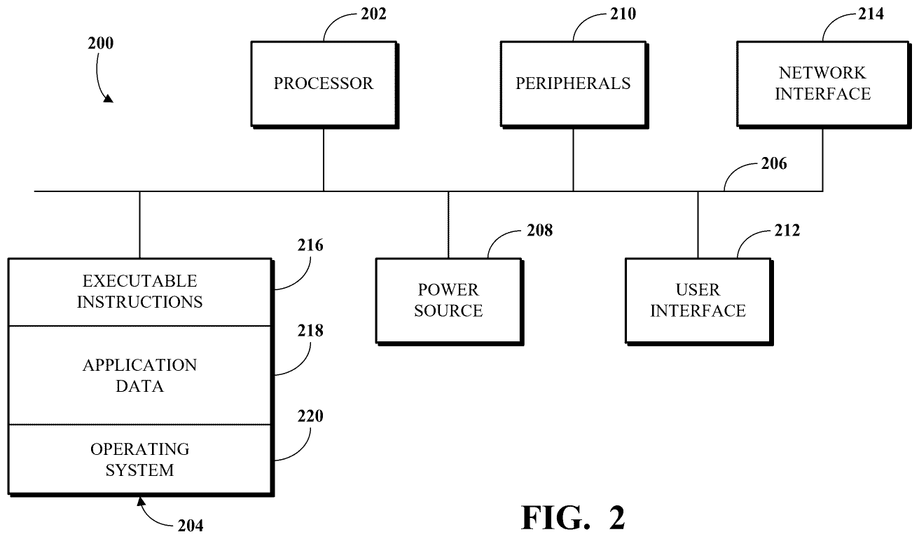

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

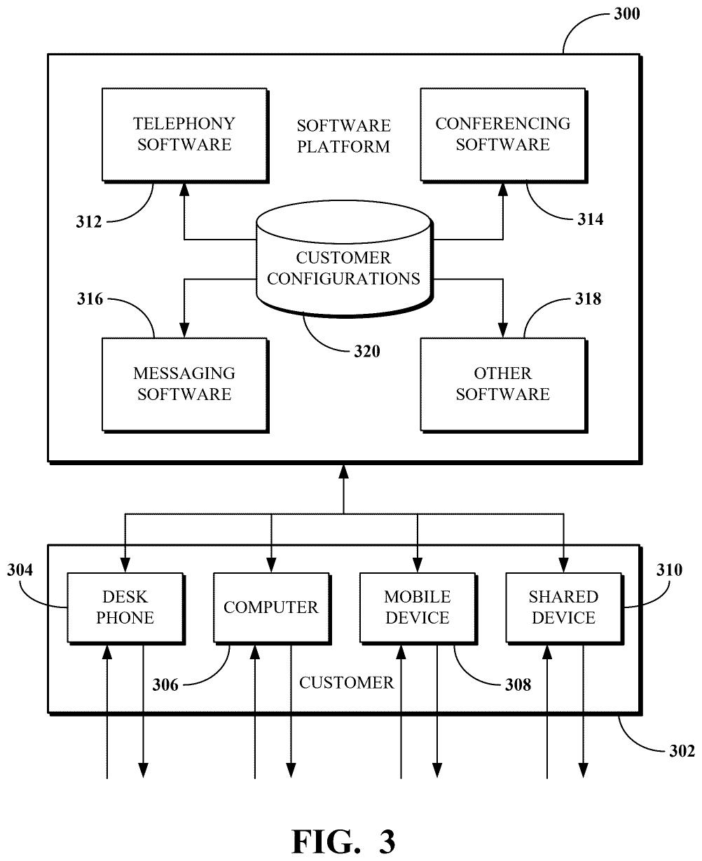

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for implementing PTT services or buffering PTT messages.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

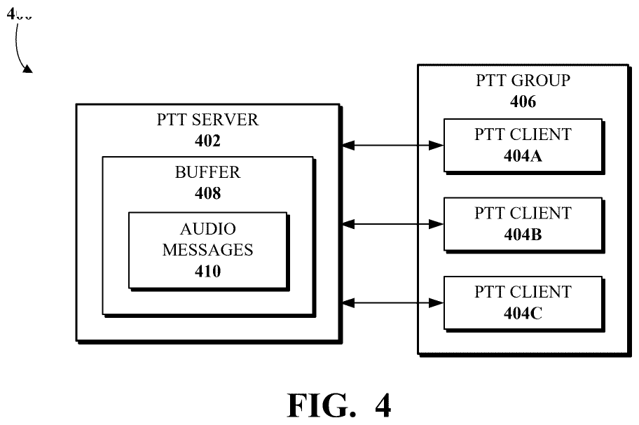

FIG. 4 is a block diagram of an example of a PTT system 400. As shown the PTT system 400 includes a PTT server 402 and multiple PTT clients 404A-C. While three PTT clients 404A-C are illustrated, the disclosed technology may be implemented with other numbers of PTT clients. The PTT server 402 may correspond to the application server 110. Each of the PTT clients 404A-C may correspond to at least one of the clients 104A-D.

The multiple PTT clients 404A-C form a PTT group 406 (e.g., a PTT network). When one PTT client 404A from the PTT group 406 transmits an audio message, the audio message is played back at the other PTT clients 404B-C in the PTT group 406. While a single PTT group 406 is illustrated in FIG. 4, the disclosed technology may be implemented with multiple PTT groups. Some of the multiple PTT groups may share a PTT server (e.g., the PTT server 402) or some of the multiple PTT groups may have their own PTT server.

As shown, the PTT server 402 includes a buffer 408 storing audio messages 410. When one PTT client 404A transmits an audio message for playback at the other PTT clients 404B-C in the PTT group 406, the PTT client 404A transmits the audio message to the PTT server 402, and the PTT server 402 forward the message to the other PTT clients 404B-C in the PTT group 406. The PTT server 402 might in some cases directly transmit the audio message upon receipt and thus might not use the buffer 408.

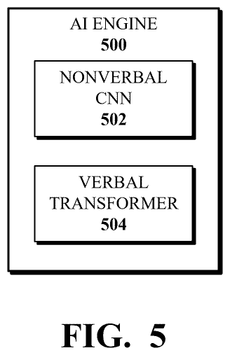

However, in some cases, while one PTT client 404A of the PTT group 406 is transmitting an audio message, another PTT client 404B in the PTT group 406 might attempt to transmit an audio message (e.g., the user of the PTT client 404B might interrupt or attempt to speak over the user of the PTT client 404A). In such circumstances, the PTT server 402 receives, while audio (e.g., of the message from the PTT client 404A) is being played back at one or more of the client devices 404A-C, one or more audio messages 410 (e.g., the audio message from the PTT client 404B) for transmission to the PTT group 406 via PTT. The PTT server 402 stores the one or more audio messages 410 in the buffer 408 in an order determine based on an initiation time of (or another time associate with) the one or more audio messages 410. The PTT server 402 uses AI techniques (e.g., as described in conjunction with FIG. 5) to determine an importance score for at least a portion of the audio messages 410 in the buffer 408. The PTT server 402 reorders the audio messages 410 in the buffer 408 based on the importance score. After the audio message that is currently being played back is terminated, the PTT server 402 transmits audio messages 410 from the buffer 408 for playback at the PTT clients 404A-C of the PTT group 406 based on an order of the audio messages 410 in the buffer 408.

It should be noted that the order of the messages received at each of the PTT clients 404A-C may be different. In one example use case, while the user of the PTT client 404A is speaking, the user of the PTT client 404B speaks the words, “alpha beta,” and the user of the PTT client 404C speaks the words, “gamma delta.” After the user of the PTT client 404A finishes speaking, the words, “alpha beta,” are played back at the PTT client 404C, and the words, “gamma delta,” are played back at the PTT client 404B. At the PTT client 404A, the words played back are either “alpha beta gamma delta,” or “gamma delta alpha beta,” with the order being determined based on the times when the messages “alpha beta” and “gamma delta” were initiated and/or using the artificial intelligence techniques described below. As a result, each PTT client 404A-C might not output the playback of the words spoken by its user.

FIG. 5 is a block diagram of an example of an AI engine 500 that may execute at the PTT server 402. The AI engine 500 may be used, for example, to determine an order of the audio messages 410 in the buffer 408 for transmission to one or more of the PTT clients 404A-C in the PTT group 406.

The AI engine 500 is configured to determine an importance score for an audio message of the audio messages 510, such that the PTT server 402 may order the audio messages in the buffer 408 based on the importance scores. As shown, the AI engine 500 includes a nonverbal CNN 502 and a verbal transformer 504. The CNN 502 and/or the verbal transformer 504 may be sub-engines of the AI engine 500.

The nonverbal CNN 502 may include a CNN configured to determine importance scores using a feature vector that includes nonverbal features of the audio messages 510. The nonverbal features may include at least one of a voice tonality, a volume, a pitch, an intonation, a rate of speech, a pause duration, spectral features, a noise level, a voice quality, a voice symmetry, a speaker distance, and an acoustic environment.

The voice tonality may include the overall quality, character, or timbre of the speaker's voice. Volume may include how loudly the speaker is speaking. The pitch may include the height or depth of the speaker's voice. The intonation may include the pattern of rises and falls in pitch that might indicate questions, exclamations, or emphasis. The rate of speech may include the speed at which the speaker is speaking, which might indicate urgency, excitement, or fatigue. The pause duration may include the length of pauses between words or phrases, which may indicate hesitation, consideration, or emphasis. The spectral features may include the distribution of energy across different frequency ranges, which may indicate the speaker's emotional state or the environment of the speaker. The noise level may include the background noise or interference present in the audio message, which may indicate the speaker's location or the quality of the recording. The voice quality may include the clarity, resonance, or richness of the speaker's voice, which may indicate their level of nervousness, excitement, or emotion. The speaker distance may include the relative distance of the speaker from the microphone, which may indicate their level of intimacy, confidence, or assertiveness. The acoustic environment may include the reverberation, echo, or damping of the audio signal, which may indicate the speaker's location, the size and shape of the room, or the presence of other objects in the environment.

To train the nonverbal CNN 502, a dataset of labeled audio examples may be used. The dataset may be manually generated by an employee of an entity responsible for training the nonverbal CNN 502, such that private messages generated by users of the PTT service are not used. The dataset may include audio recordings of messages, each associated with relevant labels indicating the non-verbal features of interest.

The audio recordings in the dataset may be preprocessed to extract relevant features. This may include techniques such as spectrogram analysis, which converts the audio signal into a visual representation of frequency content over time. The preprocessed data is then split into training and validation sets. In some examples a ratio, such as 80% for training and 20% for validation may be used.

The CNN architecture of the nonverbal CNN 502 is designed to process the extracted features and learn the relationships between the nonverbal features and the message importance. The CNN may include multiple convolutional layers, followed by pooling layers to reduce the spatial dimensions, and finally, fully connected layers to produce the output. During training, the CNN is fed with the preprocessed audio features and the corresponding labels, and the CNN learns to optimize the weights of the connections between neurons to minimize the difference between the predicted and actual labels. The optimization is typically performed using backpropagation and a loss function. In the validation phase, the CNN attempts to determine the importance scores of audio messages in the validation set, and human reviewers verify that the CNN is accurately determining the importance scores.

Once the CNN is trained, it can be used to analyze new audio messages and predict the importance based on the nonverbal features extracted from the audio. The trained model can be fine-tuned on additional datasets to adapt to specific domains or use cases, such as PTT systems for specific industries (e.g., restaurants or department stores). The CNN's ability to learn complex patterns in the data makes it a useful tool for analyzing non-verbal features in audio messages, providing valuable insights into the underlying information conveyed by the speaker.

The verbal transformer 504 may include a LLM and/or a GPT. The verbal transformer 504 processes verbal features of the audio (e.g., by converting the speech to text) to determine the importance score. For example, the audio message, “There is a fire in the warehouse-drop everything and proceed to the nearest exit immediately,” might have a higher importance score than the audio message, “Could someone please rebrew the coffee,” due to the urgency and potential danger of the former message.

In some cases, the GPT of the verbal transformer 504 is trained using a two-phase process including the phases of pretraining and finetuning. In the pretraining phase, the GPT is trained on a dataset of publicly available (e.g., from the Internet) text or audio/video data that is converted into text using speech-to-text technology. The dataset of publicly available text may include text that is distinct from PTT audio messages converted to text. For example, the dataset of publicly available text may include at least one of newspaper articles, blog posts, publicly available social media post, or encyclopedia articles. The text is used to create a language model that learns to predict the next word in a sentence given the context of the previous words. The transformer architecture, specifically the self-attention mechanism, is used to capture dependencies between words and create a representation of the text.

During pretraining, the GPT learns to generalize the patterns it observes in the training data. Specifically, the GPT learns grammar, facts, reasoning abilities, and some level of world knowledge. The pretraining phase allows the GPT to acquire a broad understanding of the natural languages in which the GPT is trained.

During the finetuning phase, after pre-training, the GPT is further finetuned on specific tasks (e.g., determining importance scores for PTT audio messages) using labeled examples. The labeled examples may be publicly available recordings of PTT audio messages (e.g., on online video hosting websites) or prompts that are manually generated by employees of an entity responsible for training the GPT. The labeled examples may include labels of desired outputs that the GPT is to generate based on the inputs. For example, an input provided to the GPT may include an audio recording of the phrase, “There is a fire in the warehouse.” The GPT should assign this audio recording a score indicating relatively high importance. Another input provide to the GPT may include an audio recording of the phrase, “The kitchen is short staffed today.” The GPT should assign this audio recording a score indicating relatively low importance. The finetuning phase makes the GPT useful for specific applications, such as assigning an importance score to a PTT audio message. Finetuning involves training the GPT on a narrower dataset that may be generated with the help of human reviewers.

The finetuning phase includes providing prompts or instructions to the GPT and receiving responses from the GPT. For example, a human reviewer may generate a set of simulated PTT audio messages, and importance scores for those simulated PTT audio messages. The human reviewers then review the output generated by the GPT and score the output according to the various qualities (e.g., did the GPT provide correct importance scores). The GPT uses reinforcement learning to attempt to improve its scores on each (or at least a subset) of the qualities as the finetuning process progresses.

As illustrated, the AI engine 500 includes both the nonverbal CNN 502 and the verbal transformer 504. In some cases, the nonverbal CNN 502 and the verbal transformer 504 work together to determine the importance score, and the AI engine 500 combines the outputs of the nonverbal CNN 502 and the verbal transformer 504 to determine the importance score of an audio message. In some implementations, the AI engine 500 may lack at least one of the nonverbal CNN 502 or the verbal transformer 504. For example, if the AI engine 500 is executing on a thin server that is not capable of running LLM or GPT software quickly (e.g., with less than 1 second of runtime), the AI engine 500 might lack the verbal transformer 504 and may determine importance scores using the nonverbal CNN 502. In some cases, the AI engine 500 may include the verbal transformer 504 and not the nonverbal CNN 502 (e.g., to reduce costs of generating or storing the nonverbal CNN 502). In some cases, the AI engine 500 may include AI technology that is different from the nonverbal CNN 502 and/or the verbal transformer 504.

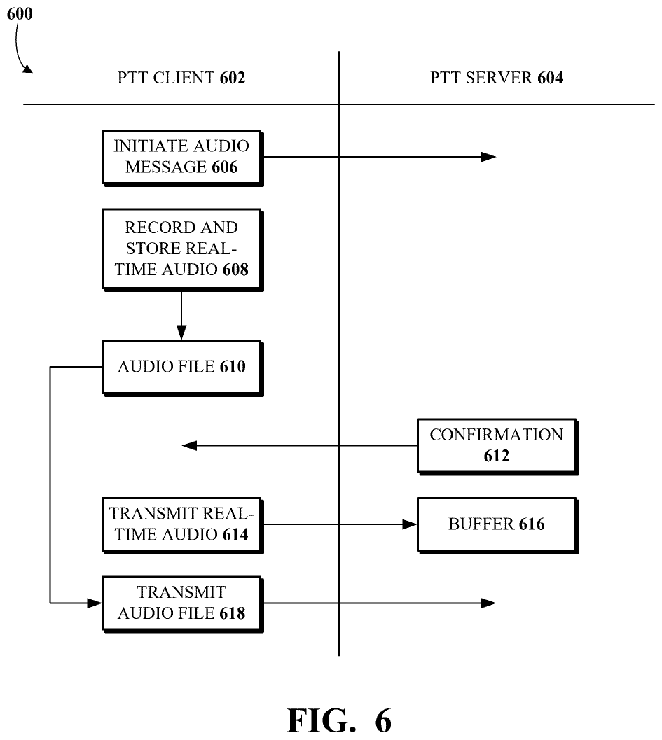

FIG. 6 is a data flow diagram of an example of a PTT communication technique 600. As shown, the PTT communication technique is performed using a PTT client 602 and a PTT server 604. The PTT client 602 may correspond to one of the PTT clients 404A-C. The PTT server 604 may correspond to the PTT server 402.

At 606, the PTT client 602 initiates an audio message. For example, the user of the client device presses a button (or navigates the graphical user interface (GUI) in another way) to initiate an audio message via PTT. In response, the PTT client 602 attempts to connect to the PTT server 604. The user may start speaking while the PTT client 602 is attempting to connect to the PTT server 604 and before the PTT client 602 is connected to the PTT server 604, as there may be latency (e.g., between 0.1 seconds and 3 second) in establishing the connection.

At 608, while the PTT client 602 is attempting to connect to the PTT server 604, the PTT client 604 records and stores real-time audio received by a microphone of or connected to the PTT client 602 (e.g., audio spoken by the user). This results in the creation of the audio file 610. In some cases, another technique for storing audio, for example, raw audio data, may be used in place of the audio file 610.

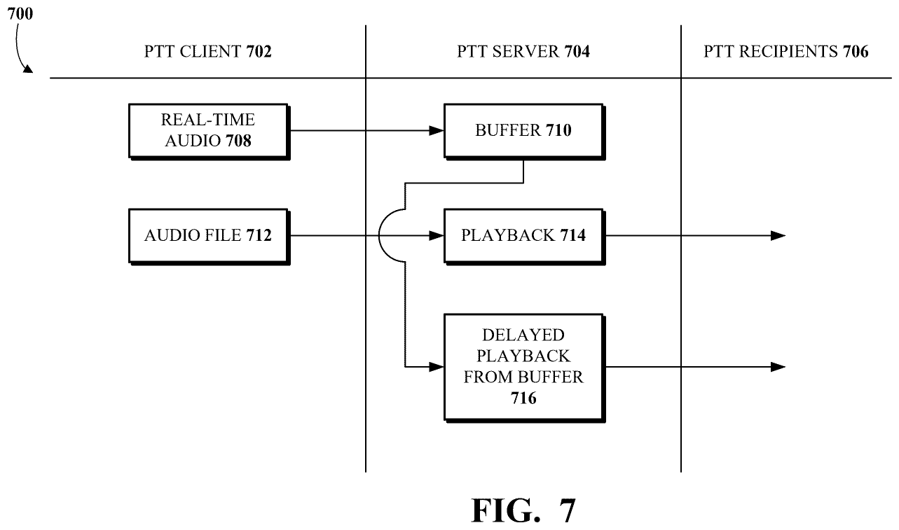

The PTT server 604 transmits, to the PTT client 602, a confirmation 612 that the connection has been established. In response, the PTT client 602 stops generating the audio file 610 and, at 614, transmits the real-time audio received via the microphone to the PTT server 604. The PTT server 604 stores the received real-time audio in a buffer 616 of the PTT server 604. At 618, the PTT client transmits the audio file 610 to the PTT server 604. As a result, the PTT server 604 receives both the audio file 610 generated before the receipt of the confirmation 612 and the real-time audio generated after receipt of the confirmation 612. Thus, the PTT server 604 has access to all of the audio spoken by the user of the PTT client 602 and does not lack the part of the audio that was generated prior to the confirmation 612. As described in conjunction with FIG. 7, the PTT server 604 may combine the audio file 610 with the audio in the buffer 616 to obtain the full audio spoken by the user of the PTT client 602 for transmission to PTT recipient devices in a PTT group of the PTT client 602.

FIG. 7 is a data flow diagram of an example of a PTT communication technique 700. In some cases, the PTT communication technique 700 is performed in conjunction with the PTT communication technique 600. Alternatively, the PTT communication technique 700 may be performed without performing the PTT communication technique 600 and/or the PTT communication technique 600 may be performed without performing the PTT communication technique 700.

As shown, the PTT communication technique 700 is performed using a PTT client 702, a PTT server 704, and PTT recipients 706. The PTT client 702 may correspond to the PTT client 602. The PTT server 704 may correspond to the PTT server 064. The PTT recipients 706 may correspond to one or more clients in the PTT group of the PTT client 702. For example, if the PTT client 702 corresponds to the PTT client 404A, the PTT recipients 702 may correspond to one or more of the other PTT clients 404B-C in the PTT group 406 of the PTT client 404A.

The PTT communication technique 700 begins when the PTT client 702 and the PTT server 704 are connected to one another (e.g., via a network such as the network 114). As shown, similarly to 614 of FIG. 6, the PTT client 702 transmits real-time audio 708 to the PTT server 704. The PTT server stores the received real-time audio in a buffer 710 (e.g., corresponding to the buffer 616). The PTT client 702 transmits the audio file 712 (or another representation of prerecorded audio) to the PTT server 704. At 714, the PTT server 704 forwards audio from the audio file to the PTT recipients 706 for playback thereat. At 716, the PTT server forwards audio from the buffer 710 to the PTT recipients for delayed (relative to a time when the audio in the buffer 710 was received) playback thereat.

To forward audio, the PTT server 704 may stream audio to the PTT recipients 706. Alternatively, the PTT server may forward the audio file 712 and/or a file (or another arrangement) of the audio in the buffer 710 for playback from the local memory of one or more of the PTT recipients 706.

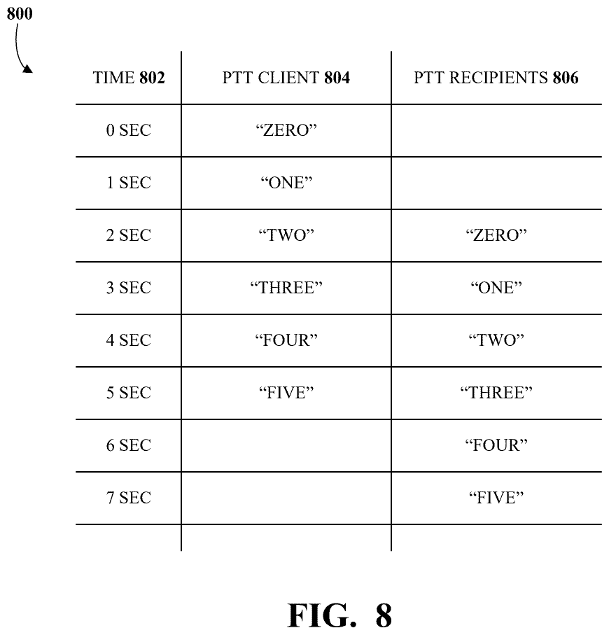

As shown, at 716, the playback of the audio from the buffer 710 is delayed. In some cases, the amount of delay may be determined based on a time duration of the audio file 712. For example, if the audio file 712 is two seconds long, the delay may be two seconds, so that the users of the PTT recipients 706 may hear the buffered audio immediately after hearing the audio file. An example is illustrated in FIG. 8 and described below. This results in a seamless listening experience for the users of the PTT recipients 706, as though the user of the PTT client 702 was physically present and speaking to them in person. In some cases, to reduce the delay for subsequent audio messages, the playback at one or more of the PTT recipients 706 may occur at a higher rate. For example, the rate may be 1.5× such that an audio that typically takes 6 seconds would be played back in 4 seconds. Whether the playback occurs at the higher rate, as well as the maximum amount of the higher rate, may be configurable at the client device. For example, a user of one of the PTT recipients 706 who wishes to process messages with minimal delay might set the maximum amount of the higher rate to 1.5× or 2×. Alternatively, a user of one of the PTT recipients 706 who receives messages in a language of which they are not a native speaker might choose not to have messages played back at a higher rate (e.g., by setting the maximum rate to 1×) or only allow a slight increase of the rate of the message (e.g., to 1.1× or 1.2×).

FIG. 8 illustrates an example of audio input and audio output of a PTT communication 800. FIG. 8 indicates the audio input and audio output by time 802 at a PTT client 804 and PTT recipients 806. The PTT client 804 may correspond to the PTT client 702. The PTT recipients 806 may correspond to the PTT recipients 706.

As shown, at time=0 seconds, the microphone of the PTT client 804 records the word “zero.” At time=1 second, the microphone of the PTT client records the word, “one.” This continues until time=5 seconds, when the microphone of the PTT client records the word, “five.” (The user of the PTT client 804 counts from zero to five at one word per second.) It takes the PTT client 804 two seconds to connect to a PTT server (e.g., the PTT server 402, 604, or 704). Thus, the words “zero” and “one” are recorded into an audio file (e.g., the audio file 610) that is transmitted to the PTT server. The words “two,” “three,” “four,” and “five,” are transmitted to the PTT server in real-time when they are spoken and stored in a buffer (e.g., the buffer 616 or the buffer 710) of the PTT server 704. At time=2 seconds, when the PTT client 804 is connected to the PTT server and the PTT server receives the audio file, the PTT server begins to transmit audio that originated at the PTT client 804 to the PTT recipients 806. As shown, this transmission causes the word “zero” to be played back at the PTT recipients 806 at time=2 seconds. At time=3 seconds, the transmission causes the word “one” to be played back at the PTT recipients 806. This continues until time=7 seconds, when the transmission causes the word “five” to be played back at the PTT recipients. Similar to the recording at the microphone of the PTT client 804, the playback at the PTT recipients 806 includes counting from zero to five, at one number per second. However, the recording at the PTT client 804 starts at time=0 seconds and continues until time=5 seconds, while the playback at the PT recipients starts at time=2 seconds and continues until time=7 seconds. The playback at the PTT recipients 806 is delayed by two seconds from the recording at the PTT client 804.

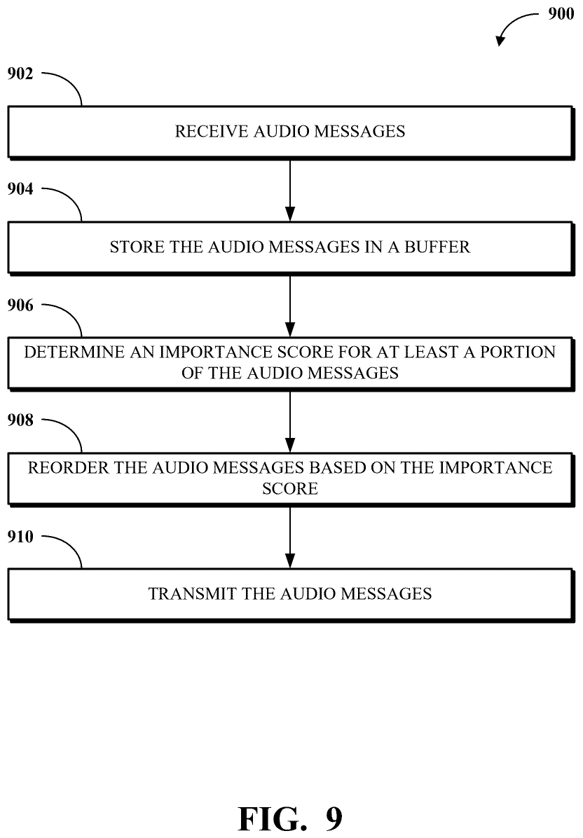

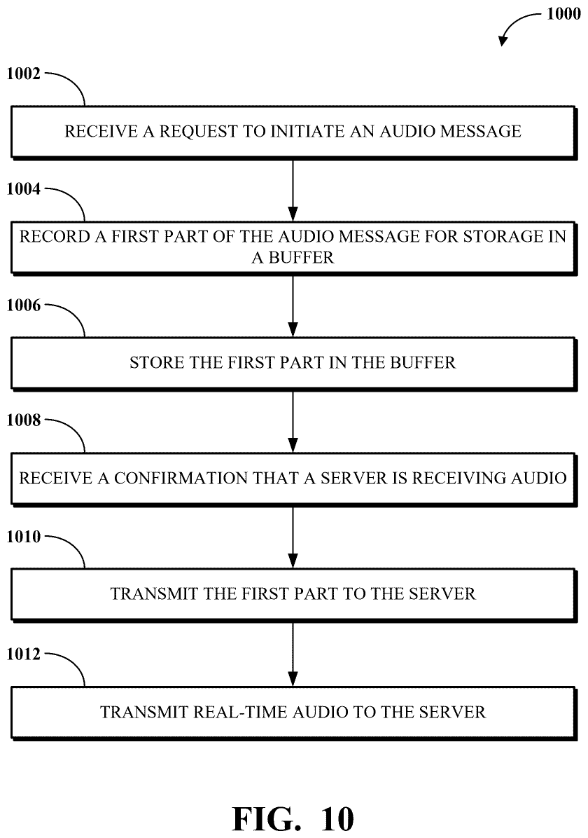

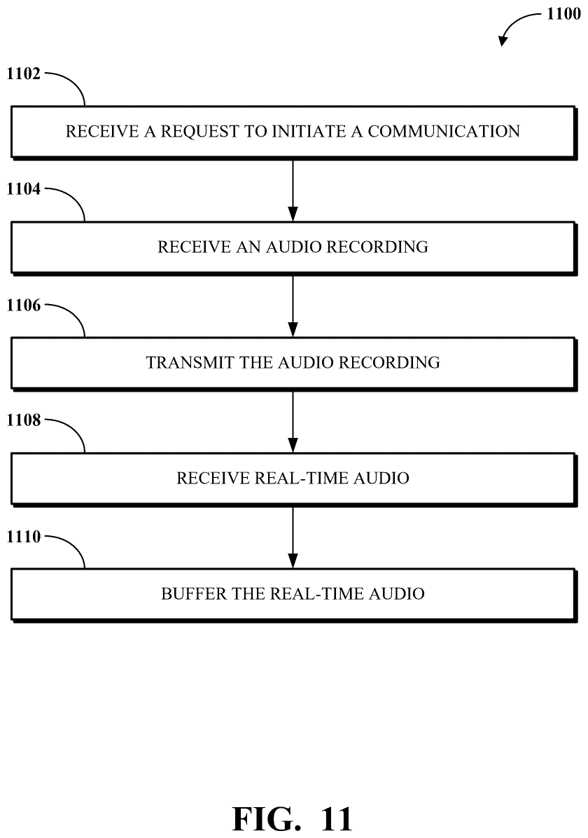

To further describe some implementations in greater detail, reference is next made to examples of techniques which may be performed by a PTT system for buffering PTT messages. FIG. 9 is a flowchart of an example of a technique 900 for buffering push-to-talk messages. FIG. 10 is a flowchart of an example of a technique 1000 for buffering a message at a client. FIG. 11 is a flowchart of an example of a technique 1100 for processing buffered audio at a server. The techniques 900, 1000, and/or 1100 can be executed using computing devices, such as the systems, hardware, and software described with respect to FIGS. 1-8. The techniques 900, 1000, and/or 1100 can be performed, for example, by executing a machine-readable program or other computer-executable instructions, such as routines, instructions, programs, or other code. The steps, or operations, of the techniques 900, 1000, 1100, or another technique, method, process, or algorithm described in connection with the implementations disclosed herein can be implemented directly in hardware, firmware, software executed by hardware, circuitry, or a combination thereof.

For simplicity of explanation, the techniques 900, 1000, and 1100 are depicted and described herein as series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 9 illustrates the technique 900 for buffering push-to-talk messages. The technique 900 may be performed by a PTT server (e.g., the PTT server 402).

At 902, the PTT server receives one or more audio messages for a PTT group (e.g., the PTT group 406) while audio is being played back at PTT client devices (e.g., at least one of the PTT client devices 404A-C) of the PTT group. The audio messages may be created, for example, by a user of a PTT client device of the PTT group attempting to speak while the PTT channel is being used by another client device of the PTT group.

At 904, the PTT server stores the one or more audio messages in a buffer (e.g., the buffer 408). The buffer is at the PTT server. The one or more audio messages are stored, in the buffer, in an order determined based at least in part on an initiation time of the one or more audio messages. In some examples, the order corresponds to the initiation times (e.g., an audio message with an earlier initiation time is before an audio message with a later initiation time).

At 906, the PTT server determines, using an AI engine (e.g., the AI engine 500) and based on nonverbal features, an importance score for at least a portion of the one or more audio messages in the buffer. The nonverbal features may include at least one of a voice tonality or a volume. In some cases, the AI engine determines the importance score based on verbal features (e.g., in addition to the nonverbal features). The verbal features may include natural language words identified based on the audio in the message (e.g., using speech-to-text technology).

In some cases, the PTT server removes at least one audio message from the buffer based on the importance score being in an unimportant range (e.g., below an unimportance threshold). This may occur, for example, if there are at least a threshold number of audio messages in the buffer in order to reduce contention for the PTT channel and the total number of messages for playback at the PTT client devices.

In some cases, the PTT server stops playback of the audio currently being played back at the PTT client devices before completion of the audio, and immediately starts playback of an audio message from the buffer, based on the importance score of the audio message being in a highly important range (e.g., exceeding a high importance threshold). In one example use case, while a boss is reading instructions to their employees via PTT, one employee presses the PTT button on their client device and says, “Medical emergency on aisle 3-call an ambulance,” in a panic-stricken tone. The PTT server uses a nonverbal AI engine (e.g., the nonverbal CNN 502) to determine the panic-stricken tone of the employee and a verbal AI engine (e.g., the verbal transformer 504) to determine that the words are associated with an emergency. Based on these determinations, the PTT server stops transmitting audio from the client device of the boss and transmits the audio from the client device of the employee, even if the boss has not yet finished speaking and is attempting to retain control of the PTT channel. In some cases, the PTT server determines, using artificial intelligence, that the employee has an emergency for which municipal emergency services (e.g., police, fire, or ambulance) may need to be summoned. In response, the PTT server may automatically summon the municipal emergency services (e.g., by telephoning 9-1-1 if located in the United States, and playing back the message from the client device of the employee to the 9-1-1 operator) and/or provide a notification to an internal emergency department of the entity associated with the PTT server (e.g., an internal emergency department of a business).

It should be noted that, in addition to the features described above, other features may be used in determining the importance score. For example, at least one of a seniority level of the user of the client device, a title of the user of the client device, importance levels of previous messages of the user of the client device, or frequency or number of messages from the user of the client device may be considered in determining the importance score. In some cases, the AI engine includes multiple artificial neural networks (ANNs). The importance score is determined by combining outputs of a first portion of the multiple ANNs by a second portion of the multiple ANNs.

At 908, the PTT server reorders the one or more audio messages based on the importance score. The reordering may be completed using any sorting technique. For example, bubble sort, merge sort, or quick sort may be used.

Bubble Sort is a simple comparison-based algorithm. It repeatedly steps through the list of audio messages in the buffer, compares the importance scores of adjacent elements, and swaps the positions of the adjacent elements if they are in the wrong order. The pass through the list is repeated until no swaps are needed, which indicates that the list is sorted.

Merge sort is a divide-and-conquer algorithm. It works by recursively dividing the unsorted list into smaller sublists until each sublist contains a single element. Then, it repeatedly merges these sublists in a manner that produces new sorted sublists until there is only one sublist remaining. This final sublist is the sorted list.

Quick Sort is another divide-and-conquer algorithm. It selects an element from the list (i.e., one of the audio messages), called a pivot, and partitions the other elements into two sub-arrays, according to whether their importance scores are less than or greater than the pivot. The sub-arrays are then sorted recursively.

At 910, the PTT server transmits the one or more audio messages for playback at the PTT client devices based on the order of the one or more audio messages in the buffer. The one or more audio messages are then played back at the PTT client devices using PTT software and/or PTT hardware at the PTT client devices.

In one example use case, an employee, Alex, who was recently let go from his job is ranting on the PTT channel about how the letting go was not fair. While Alex is ranting, Bob presses the PTT button on his client device and says, “It is not nice for Alex to rant so much.” After Bob presses the PTT button, Cindy presses the PTT button on her client device and says, “There is a major cleanup on aisle 5. I need help. Could someone bring a mop.” The PTT server stores Bob's message, followed by Cindy's message, in its buffer. The server determines importance scores for Bob's and Cindy's messages. Bob's message is assigned an importance score of 0.05 because it is not relevant to the business. Cindy's message is assigned an importance score of 0.93 because it is highly urgent and highly relevant to the business. Thus, Cindy's message is repositioned to be before Bob's message in the buffer. In some cases, the importance score of the message from Alex and/or a position of Alex or Cindy on an organizational chart or organizational hierarchy may be considered in determining whether Cindy's message may interrupt the playback of Alex's message.

The PTT server determines that the importance score of Cindy's message of 0.93 exceeds the high importance threshold of 0.9. Thus, the PTT server interrupts Alex's message and plays back Cindy's message at the PTT clients. As a result, Cindy is able to obtain assistance with the cleanup. After Cindy's message has been played back, the PTT server may cause Bob's message to be played back. Alternatively, if Alex is still attempting to speak, the PTT server may cause audio from Alex's client device to continue to be played back. After the audio from Alex's client device is finished being played back, the PTT server may cause Bob's message to be played back at the PTT client devices.

FIG. 10 illustrates the technique 1000 for buffering a message at a client. According to some implementations, the client is a PTT client, such as the PTT client 602. However, in alternative implementations, the client may use a technology different from PTT. For example, the client may be a client device being used to communicate oral instructions to a GPT engine or a personal assistant engine (e.g., implemented using AI) at a server.

At 1002, the client receives a request to initiate an audio message. If the client is a PTT client, the request to initiate the audio message may include navigating a GUI of the client to initiate a PTT message or pressing a transmit button on a PTT device that lacks a GUI (e.g., a walkie-talkie). Alternatively, other techniques for initiating the message may be used (e.g., pressing a button to initiate an oral communication with a GPT engine accessible via a network).

At 1004, the client records a first part of the audio message for storage in a buffer of the client. The first part of the audio message may be recorded while the client is attempting to connect to a server. The server may be a PTT server, such as the PTT server 604, if the client is a PTT client. In some cases, recording the first part of the audio message comprises generating an audio file (e.g., the audio file 610) including the first part.

At 1006, the client stores the first part of the audio message in the buffer. The first part of the audio message may be stored as an audio file. Alternatively, other storage or buffering techniques may be used.

At 1008, the client receives, from the server, a confirmation that the server is receiving audio of the audio message from the client. In some PTT implementations, the confirmation includes a signal that a PTT channel is locked for use by the client. In some PTT implementations, the confirmation includes a signal that the PTT channel is currently unavailable, and that the server is buffering the audio message for future transmission, for example, as described in conjunction with FIG. 9.

At 1010, the client transmits, to the server, the recorded first part of the audio message from the buffer of the client. In some PTT implementations, the transmission of the recorded first part causes the PTT server to transmit (e.g., in real-time) the recorded first part to one or more PTT recipients (e.g., the PTT recipients 706) for playback at the one or more PTT recipients.

At 1012, the client transmits, to the server, real-time audio of the audio message from the client. In some PTT implementations, the transmission of the real-time audio causes the PTT server to buffer the real-time audio for future transmission to one or more PTT recipients (e.g., the PTT recipients 706).

In one example use case, a user of a client device presses a PTT button (or other communication button, e.g., to communicate with a network-based virtual assistant) on the client device. Before the client device connects to the server, the user of the client device begins speaking and says, “we are.” The client device records the words “we are,” and saves the recording in the buffer of the client device. The client device connects to the server. The user continues speaking, saying, “running out of coffee,” oblivious to the connection event. Upon connection to the server, the client device transmits the recording of “we are” as well as the real-time audio of “running out of coffee,” to the server. The server is able to process both the “we are” audio and the “running out of coffee” audio, for example, to transmit both to recipient devices in a PTT group of the client device or to combine the parts of the received audio message to generate a response by the network-based virtual assistant.

FIG. 11 illustrates the technique 1100 for processing buffered audio at a server. The server may be a PTT server (e.g., the PTT server 704).

At 1102, the server receives a request from a client device (e.g., the PTT client 702) to initiate a PTT communication with one or more recipient devices. The server may transmit, to the client device, a confirmation that the server has connected to the client device and/or that a PTT channel is locked for use by the client device. Alternatively, the server may transmit, to the client device, a signal that a PTT channel is currently unavailable, and that the PTT server is buffering the real-time audio for future transmission (e.g., as described in conjunction with FIG. 9).

At 1104, the server receives, from the client device, an audio recording (e.g., the audio file 712) recorded during a latency period between initiation of the PTT communication at the client device and receipt of the request by the PTT server.

At 1106, the server transmits the audio recording to one or more recipient devices (e.g., the PTT recipients 706). The audio recording is transmitted for playback at the one or more recipient devices.

At 1108, the server receives real-time audio (e.g., the real-time audio 708) from the client device. The real-time audio is transmitted, from the client device to the server, as the user of the client device speaks the audio and as the audio is obtained by the microphone of the client device.

At 1110, the server buffers the real-time audio for transmission to the one or more recipient devices after completion of playback of the audio recording. The server may identify the one or more recipient devices based on their membership in a PTT group of the client device. In some cases, the server transmits the real-time audio for playback at the one or more recipient devices with a delay based on a duration of the audio recording. For example, if the duration of the audio recording is 1.5 seconds, the transmission causes the one or more recipient devices to playback the real-time audio with a delay of 1.5 seconds after it is generated (to allow for the playback of the audio recording before the playback of the real-time audio). In some cases, the server transmits the real-time audio after passage of a delay period determined based on the length of the audio recording since transmission of the audio recording. Alternatively, the server may transmit the real-time audio upon receipt, and the real-time audio may be buffered at the one or more recipient devices.

Some implementations are described below as numbered examples (Example 1, 2, 3, etc.). These examples are provided as examples only and do not limit the other implementations disclosed herein.

Example 1 is a method, comprising: receiving, at a push-to-talk server while audio is being played back at a push-to-talk client device, one or more audio messages; storing the one or more audio messages in a buffer at the push-to-talk server in an order determined based at least in part on an initiation time of the one or more audio messages; determining, using an artificial intelligence engine and based on nonverbal features, an importance score for at least a portion of the one or more audio messages in the buffer; reordering the one or more audio messages based on the importance score; and transmitting the one or more audio messages for playback at the push-to-talk client device based on the order of the one or more audio messages.

In Example 2, the subject matter of Example 1 includes, wherein the nonverbal features comprise at least one of a voice tonality or a volume.

In Example 3, the subject matter of Examples 1-2 includes, wherein determining the importance score comprises: determining the importance score based on verbal features comprising natural language words.

In Example 4, the subject matter of Examples 1-3 includes, removing at least one audio message from the buffer based on the importance score being in an unimportant range.

In Example 5, the subject matter of Examples 1-4 includes, stopping playback of the audio at the push-to-talk client device before completion of the audio; and immediately starting playback of an audio message from the buffer, based on the importance score of the audio message being in a highly important range.

In Example 6, the subject matter of Examples 1-5 includes, wherein the artificial intelligence engine comprises a convolutional neural network for processing the nonverbal features and a transformer-based engine for processing verbal features.

In Example 7, the subject matter of Examples 1-6 includes, wherein the artificial intelligence engine comprises a plurality of artificial neural networks, wherein determining the importance score comprises: combining outputs of a first portion of the plurality of artificial neural networks by a second portion of the artificial neural networks.

Example 8 is a non-transitory computer readable medium storing instructions operable to cause one or more processors to perform operations comprising: receiving, at a push-to-talk server while audio is being played back at a push-to-talk client device, one or more audio messages; storing the one or more audio messages in a buffer at the push-to-talk server in an order determined based at least in part on an initiation time of the one or more audio messages; determining, using an artificial intelligence engine and based on nonverbal features, an importance score for at least a portion of the one or more audio messages in the buffer; reordering the one or more audio messages based on the importance score; and transmitting the one or more audio messages for playback at the push-to-talk client device based on the order of the one or more audio messages.

In Example 9, the subject matter of Example 8 includes, wherein the nonverbal features comprise at least one of a voice tonality, a volume, or a pitch.

In Example 10, the subject matter of Examples 8-9 includes, wherein determining the importance score comprises: determining the importance score based on verbal features comprising natural language.

In Example 11, the subject matter of Examples 8-10 includes, the operations further comprising: removing at least one audio message from the buffer based on the importance score being in a range.

In Example 12, the subject matter of Examples 8-11 includes, the operations further comprising: stopping playback of the audio at the push-to-talk client device before completion of the audio; and starting playback of an audio message from the buffer, based on the importance score of the audio message being in an important range.

In Example 13, the subject matter of Examples 8-12 includes, wherein the artificial intelligence engine comprises a first sub-engine for processing the nonverbal features and a second sub-engine for processing verbal features.

In Example 14, the subject matter of Examples 8-13 includes, wherein the artificial intelligence engine comprises a plurality of artificial intelligence sub-engines, wherein determining the importance score comprises: combining outputs of a first portion of the plurality of artificial intelligence sub-engines by a second portion of the artificial intelligence sub-engines.

Example 15 is a system, comprising: a memory subsystem storing instructions; and processing circuitry configured to execute the instructions to: receive, at a push-to-talk server while audio is being played back at a push-to-talk client device, one or more audio messages; store the one or more audio messages in a buffer at the push-to-talk server in an order determined based at least in part on an initiation time of the one or more audio messages; determine, using an artificial intelligence engine and based on nonverbal features, an importance score for at least a portion of the one or more audio messages in the buffer; reorder the one or more audio messages based on the importance score; and transmit the one or more audio messages for playback at the push-to-talk client device based on the order of the one or more audio messages.

In Example 16, the subject matter of Example 15 includes, wherein the nonverbal features comprise at least one of a rate of speech or a pause duration.

In Example 17, the subject matter of Examples 15-16 includes, wherein to determine the importance score the processing circuitry is configured to execute the instructions to: determine the importance score based on verbal features.

In Example 18, the subject matter of Examples 15-17 includes, the processing circuitry further configured to execute the instructions to: remove at least one audio message from the buffer based on the importance score of the at least one audio message.

In Example 19, the subject matter of Examples 15-18 includes, the processing circuitry further configured to execute the instructions to: stop playback of the audio at the push-to-talk client device before completion of the audio; and start playback of an audio message from the buffer, based on the importance score.

In Example 20, the subject matter of Examples 15-19 includes, wherein the artificial intelligence engine comprises a first artificial neural network for processing the nonverbal features and a second artificial neural network for processing verbal features.

Example 21 is a method, comprising: receiving, at a push-to-talk client device, a request to initiate an audio message; recording a first part of the audio message for storage in a buffer of the push-to-talk client device; storing the first part in the buffer; receiving, from a push-to-talk server, a confirmation that the push-to-talk server is receiving audio of the audio message from the push-to-talk client device; transmitting, to the push-to-talk server, the recorded first part of the audio message from the buffer of the push-to-talk client device; and transmitting, to the push-to-talk server, real-time audio of the audio message from the push-to-talk client device.

In Example 22, the subject matter of Example 21 includes, wherein recording the first part of the audio message comprises: generating an audio file or raw audio data.

In Example 23, the subject matter of Examples 21-22 includes, wherein the confirmation comprises a signal that a push-to-talk channel is locked for use by the push-to-talk client device.

In Example 24, the subject matter of Examples 21-23 includes, wherein the confirmation comprises a signal that a push-to-talk channel is currently unavailable, and that the push-to-talk server is buffering the audio message for future transmission.

In Example 25, the subject matter of Examples 21-24 includes, wherein transmitting the real-time audio comprises: causing the push-to-talk server to buffer the real-time audio for future transmission to a recipient device.

In Example 26, the subject matter of Examples 21-25 includes, wherein transmitting the recorded first part of the audio message comprises: causing the push-to-talk server to further transmit the recorded first part of the audio message to a recipient device.

In Example 27, the subject matter of Examples 21-26 includes, wherein receiving the request to initiate the audio message comprises: receiving an indication of a selection of a transmit button of a user interface of the push-to-talk client device.

Example 28 is a non-transitory computer readable medium storing instructions operable to cause one or more processors to perform operations comprising: receiving, at a push-to-talk client device, a request to initiate an audio message; recording a first part of the audio message for storage in a buffer of the push-to-talk client device; storing the first part in the buffer; receiving, from a push-to-talk server, a confirmation that the push-to-talk server is receiving audio of the audio message from the push-to-talk client device; transmitting, to the push-to-talk server, the recorded first part of the audio message from the buffer of the push-to-talk client device; and transmitting, to the push-to-talk server, real-time audio of the audio message from the push-to-talk client device.

In Example 29, the subject matter of Example 28 includes, wherein recording the first part of the audio message comprises: generating an audio file storing the first part of the audio message.

In Example 30, the subject matter of Examples 28-29 includes, wherein the confirmation comprises a signal that a push-to-talk channel is locked for use.

In Example 31, the subject matter of Examples 28-30 includes, wherein the confirmation comprises a signal that a push-to-talk channel is currently unavailable, and that the push-to-talk server is buffering the audio message.

In Example 32, the subject matter of Examples 28-31 includes, wherein transmitting the real-time audio comprises: causing the push-to-talk server to buffer the real-time audio for future transmission.

In Example 33, the subject matter of Examples 28-32 includes, wherein transmitting the recorded first part of the audio message comprises: causing the push-to-talk server to forward the recorded first part of the audio message to a recipient device.

In Example 34, the subject matter of Examples 28-33 includes, wherein receiving the request to initiate the audio message comprises: receiving an indication of a selection of a transmit button of the push-to-talk client device.

Example 35 is a system, comprising: a memory subsystem storing instructions; and processing circuitry configured to execute the instructions to: receive, at a push-to-talk client device, a request to initiate an audio message; record a first part of the audio message for storage in a buffer of the push-to-talk client device; store the first part in the buffer; receive, from a push-to-talk server, a confirmation that the push-to-talk server is receiving audio of the audio message from the push-to-talk client device; transmit, to the push-to-talk server, the recorded first part of the audio message from the buffer of the push-to-talk client device; and transmit, to the push-to-talk server, real-time audio of the audio message from the push-to-talk client device.

In Example 36, the subject matter of Example 35 includes, wherein to record the first part of the audio message the processing circuitry is configured to execute the instructions to: generate an audio file for storage in the buffer.

In Example 37, the subject matter of Examples 35-36 includes, wherein the confirmation comprises a signal that a push-to-talk channel assigned to the push-to-talk client device.

In Example 38, the subject matter of Examples 35-37 includes, wherein the confirmation comprises a signal that a push-to-talk channel is currently unavailable, and that the push-to-talk server is storing the audio message for future transmission.

In Example 39, the subject matter of Examples 35-38 includes, wherein, to transmit the real-time audio the processing circuitry is configured to execute the instructions to: cause the push-to-talk server to store the real-time audio for future transmission to a recipient device.

In Example 40, the subject matter of Examples 35-39 includes, wherein, to transmit the recorded first part of the audio message the processing circuitry is configured to execute the instructions to: cause the push-to-talk server to transmit the recorded first part of the audio message to a device in a push-to-talk group.

Example 41 is a method, comprising: receiving, by a push-to-talk server, a request from a client device to initiate a push-to-talk communication with one or more recipient devices; receiving, from the client device, an audio recording recorded during a latency period between initiation of the push-to-talk communication at the client device and receipt of the request by the push-to-talk server; transmitting, by the push-to-talk server, the audio recording to the one or more recipient devices; receiving, by the push-to-talk server, real-time audio from the client device; and buffering, by the push-to-talk server, the real-time audio for transmission to the one or more recipient devices after completion of playback of the audio recording.

In Example 42, the subject matter of Example 41 includes, wherein the audio recording comprises an audio file or raw audio data.

In Example 43, the subject matter of Examples 41-42 includes, transmitting the real-time audio for playback at the one or more recipient devices with a delay based on a duration of the audio recording.

In Example 44, the subject matter of Examples 41-43 includes, after passage of a delay period that is based on a time length of the audio recording since transmission of the audio recording, transmitting the real-time audio for playback at the one or more recipient devices.

In Example 45, the subject matter of Examples 41-44 includes, transmitting, to the client device, a confirmation that a push-to-talk channel is locked for use by the client device.

In Example 46, the subject matter of Examples 41-45 includes, transmitting, to the client device, a signal that a push-to-talk channel is currently unavailable, and that the push-to-talk server is buffering the real-time audio for future transmission.

In Example 47, the subject matter of Examples 41-46 includes, identifying the one or more recipient devices based on stored information associated with the client device.

Example 48 is a non-transitory computer readable medium storing instructions operable to cause one or more processors to perform operations comprising: receiving, by a push-to-talk server, a request from a client device to initiate a push-to-talk communication with one or more recipient devices; receiving, from the client device, an audio recording recorded during a latency period between initiation of the push-to-talk communication at the client device and receipt of the request by the push-to-talk server; transmitting, by the push-to-talk server, the audio recording to the one or more recipient devices; receiving, by the push-to-talk server, real-time audio from the client device; and buffering, by the push-to-talk server, the real-time audio for transmission to the one or more recipient devices after completion of playback of the audio recording.

In Example 49, the subject matter of Example 48 includes, wherein the audio recording comprises at least one audio file.

In Example 50, the subject matter of Examples 48-49 includes, the operations further comprising: transmitting the real-time audio for delayed playback at the one or more recipient devices.

In Example 51, the subject matter of Examples 48-50 includes, the operations further comprising: after passage of a delay period, transmitting the real-time audio for playback at the one or more recipient devices.

In Example 52, the subject matter of Examples 48-51 includes, the operations further comprising: transmitting, to the client device, a confirmation that a push-to-talk channel is available for use by the client device.

In Example 53, the subject matter of Examples 48-52 includes, the operations further comprising: transmitting, to the client device, a signal that a push-to-talk channel is currently unavailable, and that the push-to-talk server is storing the real-time audio for future transmission.

In Example 54, the subject matter of Examples 48-53 includes, the operations further comprising: identifying the one or more recipient devices based on a push-to-talk group of the client device.

Example 55 is a system, comprising: a memory subsystem storing instructions; and processing circuitry configured to execute the instructions to: receiving, by a push-to-talk server, a request from a client device to initiate a push-to-talk communication with one or more recipient devices; receiving, from the client device, an audio recording recorded during a latency period between initiation of the push-to-talk communication at the client device and receipt of the request by the push-to-talk server; transmitting, by the push-to-talk server, the audio recording to the one or more recipient devices; receiving, by the push-to-talk server, real-time audio from the client device; and buffering, by the push-to-talk server, the real-time audio for transmission to the one or more recipient devices after completion of playback of the audio recording.

In Example 56, the subject matter of Example 55 includes, wherein the audio recording is stored in an audio file or raw audio data.

In Example 57, the subject matter of Examples 55-56 includes, the processing circuitry further configured to execute the instructions to: transmit the real-time audio for playback at the one or more recipient devices with a latency based on a duration of the audio recording.

In Example 58, the subject matter of Examples 55-57 includes, the processing circuitry further configured to execute the instructions to: after passage of a time period corresponding to a time length of the audio recording since transmission of the audio recording, transmit the real-time audio for playback at the one or more recipient devices.

In Example 59, the subject matter of Examples 55-58 includes, the processing circuitry further configured to execute the instructions to: transmit a confirmation that a push-to-talk channel is being used to transmit the audio recording and the real-time audio from client device.

In Example 60, the subject matter of Examples 55-59 includes, the processing circuitry further configured to execute the instructions to: transmit, to the client device, a signal that a push-to-talk channel is currently unavailable, and that the real-time audio is being stored for future transmission.

Example 61 is at least one machine-readable medium including instructions that, when executed by processing circuitry, cause the processing circuitry to perform operations to implement of any of Examples 1-60.

Example 62 is an apparatus comprising means to implement of any of Examples 1-60.

Example 63 is a system to implement of any of Examples 1-60.

Example 64 is a method to implement of any of Examples 1-60.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “real-time” includes, among other things, a computation being performed or a transmission being sent without any intentional delay. The computation or transmission may still be delayed, for example, due to processing latency or network latency. “Real-time” may include computation or transmission being initiated with the intent of immediate execution or delivery. While the goal is to avoid any deliberate delays, factors like processing time within a system or delays within a network can still introduce latency. As a result, even though a computation or transmission is classified as “real-time,” it might not be truly instantaneous due to inherent technical limitations.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a push-to-talk server, a request from a client device to initiate a push-to-talk communication with one or more recipient devices;
receiving, from the client device, an audio recording recorded during a latency period between initiation of the push-to-talk communication at the client device and receipt of the request by the push-to-talk server;
transmitting, by the push-to-talk server, the audio recording to the one or more recipient devices;
receiving, by the push-to-talk server, real-time audio from the client device; and
buffering, by the push-to-talk server, the real-time audio for transmission to the one or more recipient devices after completion of playback of the audio recording.

2. The method of claim 1, wherein the audio recording comprises an audio file or raw audio data.

3. The method of claim 1, further comprising:
transmitting the real-time audio for playback at the one or more recipient devices with a delay based on a duration of the audio recording.

4. The method of claim 1, further comprising:
after passage of a delay period that is based on a time length of the audio recording since transmission of the audio recording, transmitting the real-time audio for playback at the one or more recipient devices.

5. The method of claim 1, further comprising:
transmitting, to the client device, a confirmation that a push-to-talk channel is locked for use by the client device.

6. The method of claim 1, further comprising:
transmitting, to the client device, a signal that a push-to-talk channel is currently unavailable, and that the push-to-talk server is buffering the real-time audio for future transmission.

7. The method of claim 1, further comprising:
identifying the one or more recipient devices based on stored information associated with the client device.

8. A non-transitory computer readable medium storing instructions operable to cause one or more processors to perform operations comprising:
receiving, by a push-to-talk server, a request from a client device to initiate a push-to-talk communication with one or more recipient devices;
receiving, from the client device, an audio recording recorded during a latency period between initiation of the push-to-talk communication at the client device and receipt of the request by the push-to-talk server;
transmitting, by the push-to-talk server, the audio recording to the one or more recipient devices;
receiving, by the push-to-talk server, real-time audio from the client device; and
buffering, by the push-to-talk server, the real-time audio for transmission to the one or more recipient devices after completion of playback of the audio recording.

9. The non-transitory computer readable medium of claim 8, wherein the audio recording comprises at least one audio file.

10. The non-transitory computer readable medium of claim 8, the operations further comprising:
transmitting the real-time audio for delayed playback at the one or more recipient devices.

11. The non-transitory computer readable medium of claim 8, the operations further comprising:
after passage of a delay period, transmitting the real-time audio for playback at the one or more recipient devices.

12. The non-transitory computer readable medium of claim 8, the operations further comprising:
transmitting, to the client device, a confirmation that a push-to-talk channel is available for use by the client device.

13. The non-transitory computer readable medium of claim 8, the operations further comprising:
transmitting, to the client device, a signal that a push-to-talk channel is currently unavailable, and that the push-to-talk server is storing the real-time audio for future transmission.

14. The non-transitory computer readable medium of claim 8, the operations further comprising:
identifying the one or more recipient devices based on a push-to-talk group of the client device.

15. A system, comprising:
a memory subsystem storing instructions; and
processing circuitry configured to execute the instructions to:
receiving, by a push-to-talk server, a request from a client device to initiate a push-to-talk communication with one or more recipient devices;
receiving, from the client device, an audio recording recorded during a latency period between initiation of the push-to-talk communication at the client device and receipt of the request by the push-to-talk server;
transmitting, by the push-to-talk server, the audio recording to the one or more recipient devices;
receiving, by the push-to-talk server, real-time audio from the client device; and
buffering, by the push-to-talk server, the real-time audio for transmission to the one or more recipient devices after completion of playback of the audio recording.

16. The system of claim 15, wherein the audio recording is stored in an audio file or raw audio data.

17. The system of claim 15, the processing circuitry further configured to execute the instructions to:
transmit the real-time audio for playback at the one or more recipient devices with a latency based on a duration of the audio recording.

18. The system of claim 15, the processing circuitry further configured to execute the instructions to:
after passage of a time period corresponding to a time length of the audio recording since transmission of the audio recording, transmit the real-time audio for playback at the one or more recipient devices.

19. The system of claim 15, the processing circuitry further configured to execute the instructions to:
transmit a confirmation that a push-to-talk channel is being used to transmit the audio recording and the real-time audio from client device.

20. The system of claim 15, the processing circuitry further configured to execute the instructions to:
transmit, to the client device, a signal that a push-to-talk channel is currently unavailable, and that the real-time audio is being stored for future transmission.
